(19) United States
(12) Patent Application Publication
(10) Pub. No.: US 2013/0188006 A1
(43) Pub. Date: Jul. 25, 2013

(54) Internet Video Chat Capable Television with Personal Computer Hardware

(71) Applicant: Daniel A. McMahon, Boston, MA (US)

(72) Inventor: Daniel A. McMahon, Boston, MA (US)

(21) Appl. No.: 13/633,665

(22) Filed: Oct. 2, 2012

Related U.S. Application Data
(60) Provisional application No. 61/589,943, filed on Jan. 24, 2012.

(51) Int. Cl. H04N 7/14

(52) U.S. Cl. 348/14.04; 348/E07.079

(57) ABSTRACT

An internet video chat capable television with personal computer hardware has a digital screen, a tuner, a camera, a microphone, and a plurality of wireless communication devices and wireless or wired communication ports for connecting to the internet or another digital network and accessories such as a remote, keyboard or a headset. A motherboard, central processing unit, solid state hard drive and associated chipset and other electronic components on par with a personal computer enable installation of a full operating system capable of supporting web applications such as Voice over Internet Protocol and video communications as well as home security, home automation and child minding applications, among many others, without the need for a separate computer. The camera has an infrared option for video monitoring in low light conditions.

The current application claims a priority to the U.S. Provisional Patent application Ser. No. 61/589,943 filed on Jan. 24, 2012.

### FIELD OF THE INVENTION

The present invention relates generally to televisions. More particularly, the present invention relates to a television with a camera, a microphone, internet connectivity, and personal computer hardware.

### BACKGROUND OF THE INVENTION

Television, or TV, is a telecommunication medium for transmitting and receiving moving images. A TV set, also known as just a TV, is a device that combines a tuner, a visual display, and audio speakers for the purpose of viewing television. Commercially available since the late 1920s, the TV has become commonplace in homes, businesses and institutions, particularly as a vehicle for advertising, a source of entertainment, and news. A standard TV comprises multiple internal electronic circuits, including those for receiving and decoding broadcast signals. As of 2011, 48 million TVs are sold each year in North America at an average price of $460.

Recently, many people have begun to receive at least a portion of their TV entertainment from their personal computer, through downloading show episodes or movies from the internet, or using streaming TV-like services. Doing so requires that the user watch the programs on their computer, connect their computer to their TV, or use an expensive third-party device connected to their TV.

Many TVs offered by leading manufacturers today are equipped with web connectivity and offer access to web based applications; however, they are unable to leverage a standard PC Operating System Interface and applications such as web based Voice Over Internet Protocol (VoIP) internet telephony and video communications applications such as Skype, which has the benefit of reducing communication bills. A TV set with a camera, a microphone and a robust hardware package on par with a personal computer is desired, to facilitate VoIP or internet video calling as well as other applications such as live video monitoring for infants or home security or home automation purposes, without the need for a separate personal computer.

It is therefore an object of the present invention to provide an internet capable TV with a camera, microphone and personal computer chipset, processor and associated hardware capable of running a standard personal computer operating system and facilitating applications such as VoIP and video communications, security and monitoring software as well as receiving standard TV channels and services without the need for a separate computer.

### BRIEF DESCRIPTION OF THE DRAWINGS

FIG. 1 is a front perspective view of the present invention with the at least one camera mounted atop the screen frame.

FIG. 2 is a front perspective view of the present invention with the at least one camera held within the screen frame.

FIG. 3 is a side view of the present invention showing one possible placement and arrangement of the plurality of data ports.

FIG. 4 is a diagram illustrating connectivity of the present invention with remote control devices and the RFID reader.

FIG. 5 is a block diagram generally describing the electronic components of the present invention.

FIG. 6 is a block diagram describing the connections between the electronic components of the present invention.

### DETAIL DESCRIPTIONS OF THE INVENTION

All illustrations of the drawings are for the purpose of describing selected versions of the present invention and are not intended to limit the scope of the present invention.

The present invention is an internet video chat capable television with integrated personal computer hardware. The present invention comprises a housing 1, a digital screen 2, a plurality of speakers 3, at least one camera 4, a microphone 5, personal computer hardware 6, a plurality of data ports 7, a plurality of wireless communication devices 8, a security device 9, a remote 13, and a tuner 10.

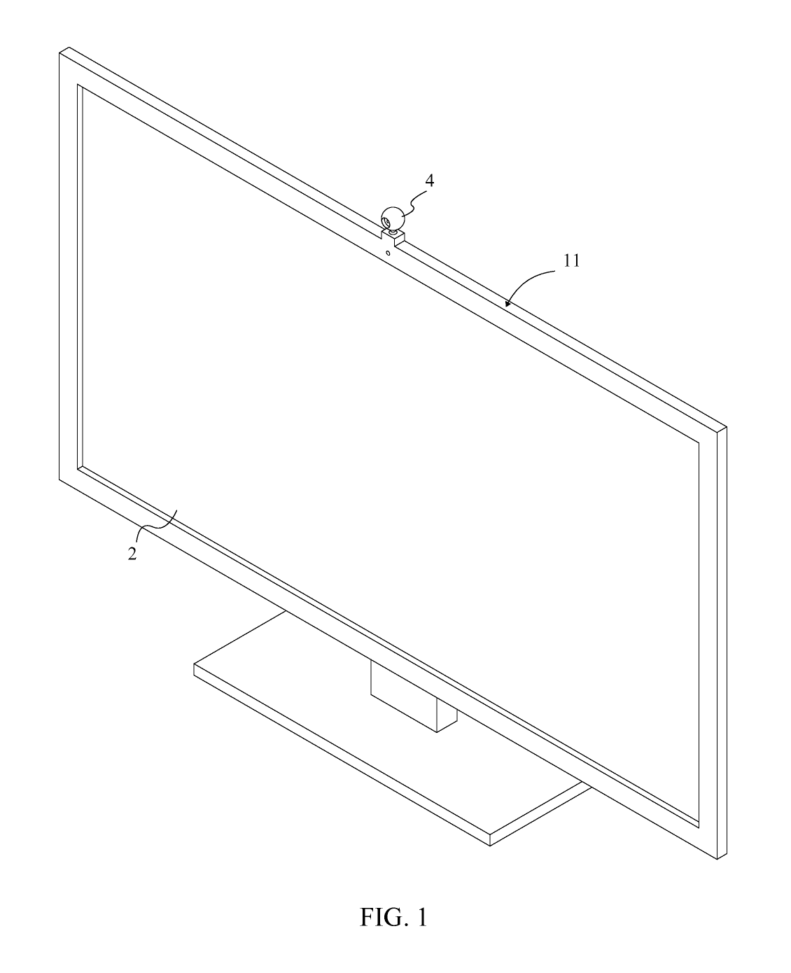

Referring to FIG. 1-3, the housing 1 is a rigid shell, preferably made of plastic or another polymer that supports, either inside or on the housing 1, the other components of the present invention. The housing 1 comprises a screen frame 11 and a back enclosure 12. The screen frame 11 is rectangular in shape and perimetrically connected around the digital screen 2, supporting the digital screen 2 in an upright orientation in a manner common to TVs. The back enclosure 12 is perimetrically connected to the screen frame 11. The majority of the electronic hardware is located within the back enclosure 12.

The digital screen 2 is an electronic display which performs as a visual output device to display electronically received, arbitrary images without producing a permanent record. The digital screen 2 utilizes commonly known technology for TVs, computer monitors or other digital displays, which may include, but is not limited to, a liquid crystal display (LCD), a light emitting diode (LED) display, a cathode ray tube (CRT) display, or a plasma display panel.

The plurality of speakers 3 is a number of electroacoustic transducers that produce sound in response to an electrical audio signal input. The plurality of speakers 3 functions in combination with the digital screen 2 to provide a sensory feedback system for the user, facilitating watching television programs or movies, listening to music, or other audio, visual or audio-visual functionalities. The plurality of speakers 3 is positioned equidistantly and perimetrically around the digital screen 2 within the housing 1 in an arrangement that appropriately facilitates an even and clear distribution of sound to a user.

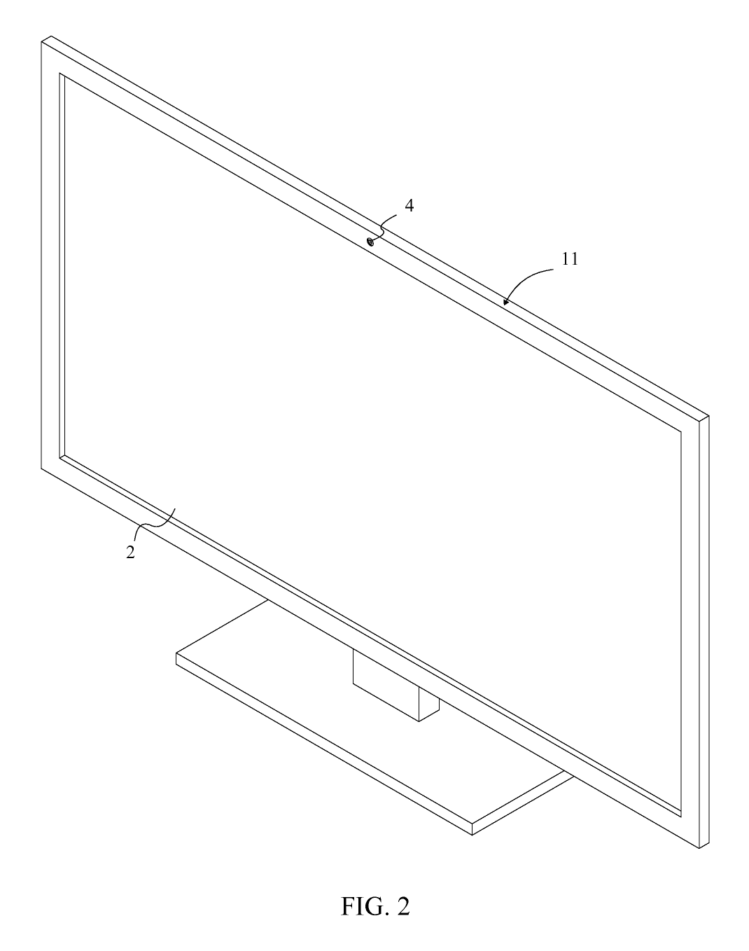

The at least one camera 4 is a well known electronic device that records digital images for the purpose of internet video chat, security or child monitoring, or other purposes. Referring to FIG. 1-2, the at least one camera 4 is positioned centrally at the top of the screen frame 11. Preferably, the at least one camera 4 is mounted on a pivoted support such as a gimbal or a ball and socket joint in order to provide a wide range of possible orientations of the at least one camera 4. In the preferred embodiment of the present invention, the at least one camera is held within the screen frame in a manner similar to cameras built in to laptop computers, as can be seen in FIG. 2. In an alternate embodiment of the present invention, the at least one camera is mounted atop the screen frame, as can be seen in FIG. 1. The at least one camera 4 comprises a standard camera 41 and an infrared camera 42 for video monitoring in low light conditions. In the preferred embodiment of the present invention, the standard camera 41 and the infrared camera 42 are comprised in a single camera unit with the capability of switching between the standard and infrared functions. In another embodiment of the present invention, the standard camera 41 and the infrared camera 42 are two separate units positioned adjacently to each other.

The microphone 5 is a well known technology that uses an acoustic-to-electric transducer or sensor to convert sound into an electrical signal. The microphone 5 is positioned on the screen frame 11 so that a person utilizing the present invention to engage in video chat or other audio recording applications has a direct line of sight to the microphone 5 and the sound waves are not physically impeded. The microphone 5 preferably incorporates previously known noise-canceling technology to filter out ambient noise from the desired sound for clear audio signals.

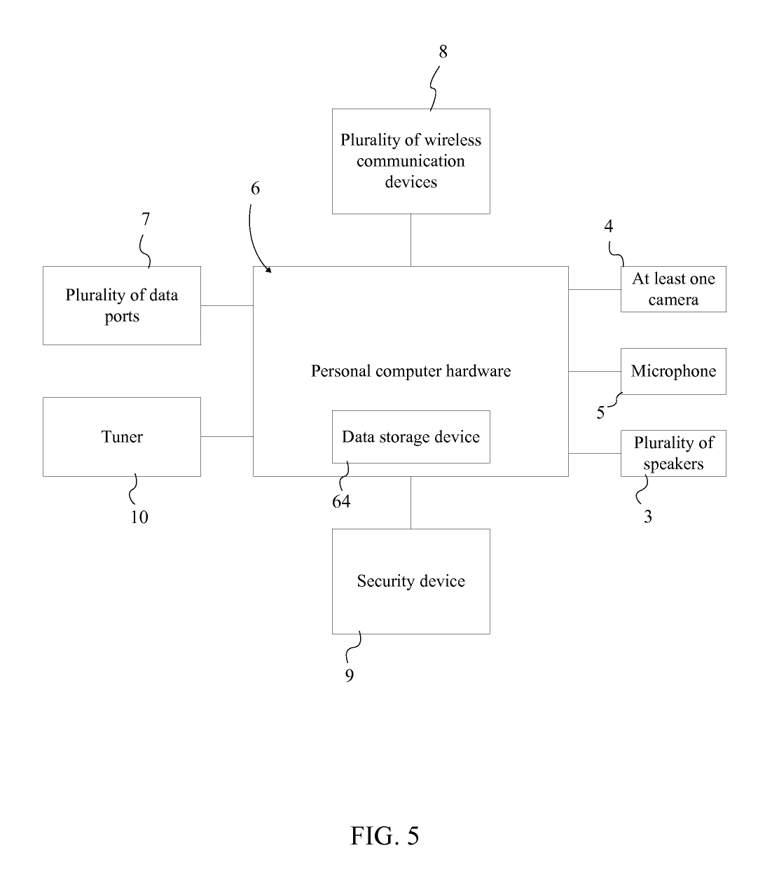

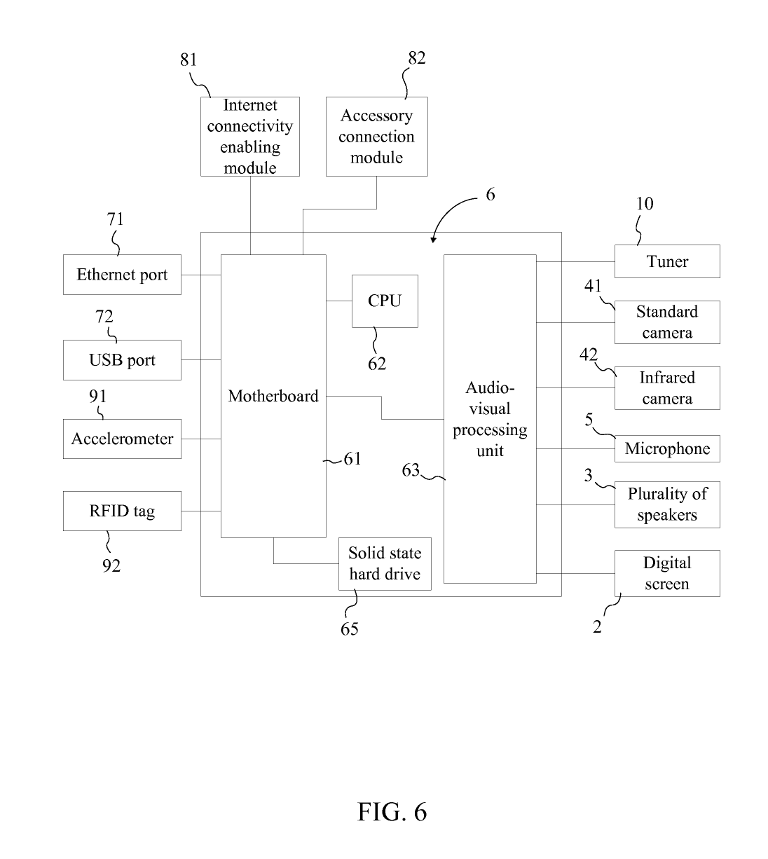

Referring to FIGS. 5-6, the personal computer hardware 6 is a collection of well known electronic components typical to a personal computer that enable installation of a full operating system and applications for a personal computer. To minimize physical space occupied within the housing 1, the personal computer hardware 6 is preferably of a compact variety similar to that utilized in a common type of laptop computers known as netbooks. The personal computer hardware 6 comprises a motherboard 61, a central processing unit (CPU) 62, an audio-visual processing unit 63, and a data storage device 64. In the preferred embodiment of the invention, the data storage device 64 is a solid state hard drive 65. Since a standard operating system is supported, full file exploring of any wireless or wired storage device can be configured to be available from the TV itself or from a smartphone application so that multimedia files from physically or wirelessly connected storage drives may be accessed and displayed. A wide variety of third-party programs and applications may be downloaded or installed to provide additional functionality to the present invention, such as enabling the present invention to act as a user interface for third party home automation systems that have traditionally been installed on a home personal computer that is connected to the internet. The consumer is also enabled to control home lighting, heating, cooling and other home control characteristics through a third-party application and a wireless or wired network.

The motherboard 61 is a printed circuit board which holds many of the crucial components of a computer system such as the CPU 62 and memory and provides connectors for other peripherals. The motherboard 61 is a well-known component of computing devices that provides the electrical connections by which the other components of the system communicate, and functions as the primary control hub of the system. The chipset of the motherboard 61 provides supporting interfaces between the CPU 62 and the various buses, or information exchange subsystems, and external components. The CPU 62, also a well-known component of computing devices, is a silicon chip within the electronic system of the present invention that carries out the instructions of a computer program by performing the basic arithmetical, logical, and input/output operations of the system.

The audio-visual processing unit 63 is an arrangement of hardware, preferably a sound card and a graphics card, that receives data regarding audio or video, performs appropriate processing of the data, and sends the end results to the appropriate output locations. Preferably, the graphics card is a graphics processing unit, a well-known component of personal computers that is a specialized electronic circuit designed to rapidly manipulate and alter memory to accelerate the building of images in a frame buffer intended for output to a display. Preferably, the sound card, also a well-known component of personal computers, is an internal computer expansion card that facilitates the input and output of audio signals to and from a computer under control of computer programs. The motherboard 61, CPU 62, audio-visual processing unit 63, and data storage device 64 are positioned within the back enclosure 12.

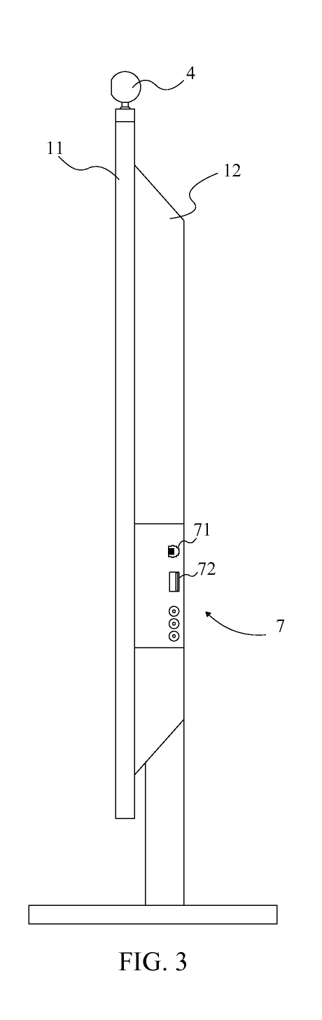

Referring to FIG. 3, the plurality of data ports 7 comprises a number of physical electronic connections including, but not limited to, an ethernet port 71 and a universal serial bus (USB) port 72. Each of the plurality of data ports 7 is positioned through the back enclosure 12. The ethernet port 71 is a well-known physical interface socket for an ethernet cable which facilitates a wired connection to the internet. The USB port 72 is also a well-known standard physical interface socket, generally used for interfacing with accessories such as an external hard drive, mouse, keyboard, or CD/DVD drive. Other common data ports may also be included, such as, but not limited to, standard composite and component AV connectors, an HDMI port, or ⅛ inch or ¼ inch audio jack plugs, as well as typical TV audio and video input and output connections, such as RCA inputs and outputs or other coaxial cables such as typical cable TV carrier cables.

The plurality of wireless communication devices 8 comprises an internet connectivity enabling module 81 and an accessory connection module 82. The plurality of wireless communication devices 8 is positioned between the back enclosure 12 and the digital screen 2, or in another location that is hidden from a user's view. The internet connectivity enabling module 81 is a device that utilizes well-known wireless radio communication technology to connect to a wireless local area network, preferably utilizing the Institute of Electrical and Electronics Engineers' 802.11 standards. Multiple of the present invention may be installed and may communicate with each other through a wireless network enabled by the internet connectivity enabling module 81 or the ethernet port 71.

The accessory connection module 82 is also a device that utilizes well-known wireless radio communication technology to establish a communicative connection with accessories, such as a voice headset, mouse, keyboard, remote control or other accessories. The accessory connection module 82 preferably utilizes short-wavelength radio transmissions in the industrial, scientific and medical radio band from 2400 to 2480 megahertz. Additional sensors and cameras may be introduced into the system through the accessory connection module for enhanced security purposes.

The combination of the personal computer hardware 6, the internet connectivity enabling module 81, the ethernet port 71, the at least one camera 4, and the microphone 5 enables the use of web based security monitoring and alert systems, streaming real time video monitoring data to a smart phone, a local, offsite or cloud location, child monitoring applications and many other functions without the need for a separate computer or web cam.

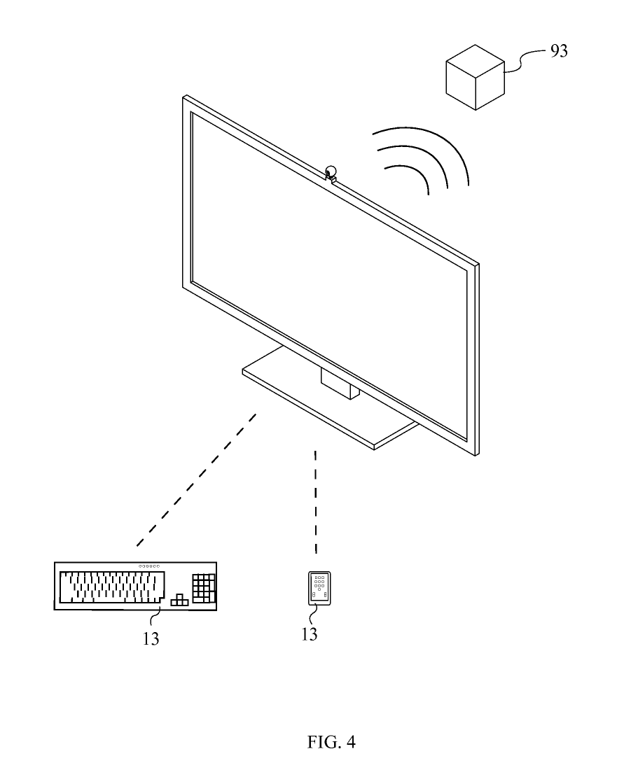

The security device 9 is a sensor or system that enhances security of the television or the owner's home by deterring theft of the present invention and alerting the owner upon detection of possible security threats. In the preferred embodiment of the present invention, the security device 9 comprises an accelerometer 91 and is positioned within the housing 1. The present invention can be configured so that if the accelerometer 91 detects a disturbance of the present invention, an audible alarm is sounded from the plurality of speakers 3 and the owner is alerted in at least one of several ways through a home security application, such as a text message to their mobile phone, an e-mail or a phone call. Referring to FIG. 4, in another embodiment of the present invention, the security device 9 is a radio frequency identification (RFID) tag 92 and a reader 93. The RFID tag 92 is positioned within the housing 1 and the reader is positioned outside the housing 1 in close proximity. The reader continually detects the presence of the RFID tag 92. If the present invention is removed from the proximity of the reader, the reader 93 no longer detects the presence of the RFID tag 92, triggering a security alert through a connection to the owner's home network or another appropriate network. Preferably, the RFID tag 92 is of the active variety, requiring a power source to continually transmit its identification signal to the reader 93.

The remote 13 is a portable device physically separate from the television that allows a user to operate the television from a distance. In the preferred embodiment of the invention, the remote 13 comprises a QWERY keyboard as well as channel, volume and input controls typical to television remote 13 control units and is communicatively coupled with the motherboard 61 through the accessory connection module 82. A third party personal computer keyboard or mouse may also be connected in order to control the present invention through the accessory connection module 82 or using a wired connection through the USB port 72. In alternate embodiments of the invention, the remote 13 utilizes line-of-sight infrared pulses emitted by a transmitted in the remote 13 and received by a receiver in the television, preferably on the housing 1. Another capability of the present invention enabled by a full operating system is to enable the use of a smartphone as the remote 13 utilizing a third-party application interface, as illustrated in FIG. 3.

The tuner 10 is a well-known piece of equipment commonly packaged with TVs that converts a radio frequency analog television transmission or digital television transmission into audio and video signals which can be further processed to produce sound and a picture in order for the user to be able to watch TV on various channels. The tuner 10 preferably is capable of tuning both digital and analog signals.

The preferred embodiment of the present invention also comprises an optical disk reader for reading optical disks such as CDs, DVDs and other optical disks. The optical disk reader traverses into the housing 1 and is electronically connected to the motherboard 61. The optical CD/DVD drive is optional to be permanently integrated into the present invention as an external CD/DVD drive may be connected via the USB port 72 to perform the same functions.

Referring to FIGS. 5-6, the motherboard 61 is electronically connected to the CPU 62, the audio-visual processing unit 63, the data storage device 64, the plurality of data ports 7, the security device 9, and the plurality of wireless communication devices 8. The motherboard 61 is also electronically connected to other necessary or peripheral electronic components. The audio-visual processing unit 63 is electronically connected to the at least one camera 4, the digital screen 2, the microphone 5, the plurality of speakers 3, and the tuner 10.

Although the invention has been explained in relation to its preferred embodiment, it is to be understood that many other possible modifications and variations can be made without departing from the spirit and scope of the invention as hereinafter claimed.

What is claimed is,:

1. An internet video chat capable television with integrated personal computer hardware comprises,
a housing;
a digital screen;
a plurality of speakers;
at least one camera;
a microphone;
personal computer hardware;
a plurality of data ports;
a plurality of wireless communication devices;
a security device;
a tuner;
the personal computer hardware comprises a motherboard, a central processing unit (CPU), an audio-visual processing unit, and a data storage device;
the plurality of data ports comprises an ethernet port and a universal serial bus (USB) port; and
the plurality of wireless communication devices comprises an internet connectivity enabling module and an accessory connection module.

2. The internet video chat capable television with integrated personal computer hardware as claimed in claim 1 comprises,
the housing comprises a screen frame and a back enclosure;
the screen frame being perimetrically connected around the digital screen;
the back enclosure being perimetrically connected to the screen frame;
the motherboard, the CPU, the audio-visual processing unit, the data storage device, the plurality of data ports, the plurality of wireless communication devices, and the tuner being positioned between the back enclosure and the digital screen;
the at least one camera being centrally positioned within the screen frame;
the microphone being positioned on the screen frame;
the plurality of speakers being positioned within the housing;
the plurality of speakers being equidistantly and perimetrically positioned around the digital screen; and
the plurality of data ports being positioned through the back enclosure.

3. The internet video chat capable television with integrated personal computer hardware as claimed in claim 1 comprises,
the motherboard being electronically connected to the CPU, the audio-visual processing unit, the data storage device, the plurality of data ports, and the plurality of wireless communication devices; and
the audio-visual processing unit being electronically connected to the at least one camera, the digital screen, the microphone, the plurality of speakers, and the tuner.

4. The internet video chat capable television with integrated personal computer hardware as claimed in claim 1 comprises,
the security device comprises an accelerometer;
the accelerometer being electronically connected to the motherboard; and
the accelerometer being positioned within the housing.

5. The internet video chat capable television with integrated personal computer hardware as claimed in claim 1 comprises,
the security device comprises a radio frequency identification (RFID) tag and a reader;
the RFID tag being positioned within the housing;
the reader being positioned outside the housing; and
the RFID tag being electronically connected to the mother board.

6. The internet video chat capable television with integrated personal computer hardware as claimed in claim 1, wherein the data storage device is a solid state hard drive.

7. The internet video chat capable television with integrated personal computer hardware as claimed in claim 1 comprises,
a remote;
the remote being positioned outside of the housing; and
the remote being communicatively coupled to the motherboard through the accessory connection module.

8. The internet video chat capable television with integrated personal computer hardware as claimed in claim 7, wherein the remote comprises a QWERTY keyboard.

9. The internet video chat capable television with integrated personal computer hardware as claimed in claim 1, wherein the digital screen is a liquid crystal display, a light emitting diode display, or a plasma screen.

10. The internet video chat capable television with integrated personal computer hardware as claimed in claim 1 comprises,
the at least one camera comprises a standard camera and an infrared camera;
the standard camera and the infrared camera being centrally positioned within the screen frame;
the standard camera and the infrared camera being adjacently positioned to each other; and
the standard camera and the infrared camera being electronically connected to the audio-visual processing unit.

11. An internet video chat capable television with integrated personal computer hardware comprises,
a housing;
a digital screen;
a plurality of speakers;
at least one camera;
a microphone;
personal computer hardware;
a plurality of data ports;
a plurality of wireless communication devices;
a security device;
a tuner;
the personal computer hardware comprises a motherboard, a central processing unit (CPU), an audio-visual processing unit, and a data storage device;
the plurality of data ports comprises an ethernet port and a universal serial bus (USB) port;
the plurality of wireless communication devices comprises an internet connectivity enabling module and an accessory connection module;
the data storage device being a solid state hard drive; and
the at least one camera comprises a standard camera and an infrared camera;

12. The internet video chat capable television with integrated personal computer hardware as claimed in claim 11 comprises,
the housing comprises a screen frame and a back enclosure;
the screen frame being perimetrically connected around the digital screen;
the back enclosure being perimetrically connected to the screen frame;
the motherboard, the CPU, the audio-visual processing unit, the data storage device, the plurality of data ports, the plurality of wireless communication devices, and the tuner being positioned between the back enclosure and the digital screen;
the microphone being positioned on the screen frame;
the standard camera and the infrared camera being centrally positioned within the screen frame;
the standard camera and the infrared camera being adjacently positioned to each other;
the plurality of speakers being positioned within the housing;
the plurality of speakers being equidistantly and perimetrically positioned around the digital screen;
the plurality of data ports being positioned through the back enclosure;
the motherboard being electronically connected to the CPU, the audio-visual processing unit, the solid state hard drive, the plurality of data ports, and the plurality of wireless communication devices; and
the audio-visual processing unit being electronically connected to the standard camera, the infrared camera, the digital screen, the microphone, the plurality of speakers, and the tuner.

13. The internet video chat capable television with integrated personal computer hardware as claimed in claim 11 comprises,
the security device comprises an accelerometer;
the accelerometer being positioned within the housing; and
the accelerometer being electronically connected to the motherboard.

14. The internet video chat capable television with integrated personal computer hardware as claimed in claim 11 comprises,
the security device comprises a radio frequency identification (RFID) tag and a reader;
the RFID tag being positioned within the housing;
the reader being positioned outside the housing; and
the RFID tag being electronically connected to the motherboard.

15. The internet video chat capable television with integrated personal computer hardware as claimed in claim 11 comprises,
a remote, wherein the remote is a QWERTY keyboard;
the remote being positioned outside of the housing;
the remote being communicatively coupled to the motherboard through the accessory connection module; and
the digital screen being a liquid crystal display, a light emitting diode display, or a plasma screen.

16. An internet video chat capable television with integrated personal computer hardware comprises,
a housing;
a digital screen;
a plurality of speakers;
at least one camera;
a microphone;
personal computer hardware;
a plurality of data ports;
a plurality of wireless communication devices;
a security device;
a tuner;
a remote;
the personal computer hardware comprises a motherboard, a central processing unit (CPU), an audio-visual processing unit, and a data storage device;
the plurality of data ports comprises an ethernet port and a universal serial bus (USB) port;
the plurality of wireless communication devices comprises an internet connectivity enabling module and an accessory connection module;
the housing comprises a screen frame and a back enclosure;
the screen frame being perimetrically connected around the digital screen;
the back enclosure being perimetrically connected to the screen frame;
the motherboard, the CPU, the audio-visual processing unit, the data storage device, the plurality of data ports, the plurality of wireless communication devices, and the tuner being positioned between the back enclosure and the digital screen;
the plurality of speakers being positioned within the housing;
the plurality of speakers being equidistantly and perimetrically positioned around the digital screen;
the plurality of data ports being positioned through the back enclosure;
the data storage device being a solid state hard drive;
the remote being positioned outside of the housing;
the remote being communicatively coupled to the motherboard through the accessory connection module;
the at least one camera comprises a standard camera and an infrared camera;
the standard camera and the infrared camera being centrally positioned within the screen frame;
the standard camera and the infrared camera being adjacently positioned to each other;
the standard camera and the infrared camera being electronically connected to the audio-visual processing unit;
the motherboard being electronically connected to the CPU, the audio-visual processing unit, the data storage device, the plurality of data ports, and the plurality of wireless communication devices; and
the audio-visual processing unit being electronically connected to the standard camera, the infrared camera, the digital screen, the microphone, the plurality of speakers, and the tuner.

17. The internet video chat capable television with integrated personal computer hardware as claimed in claim 16 comprises,
the security device comprises an accelerometer;
the accelerometer being electronically connected to the motherboard; and
the accelerometer being positioned within the housing.

18. The internet video chat capable television with integrated personal computer hardware as claimed in claim 16 comprises,
the security device comprises a radio frequency identification (RFID) tag and a reader;
the RFID tag being positioned within the housing;
the reader being positioned outside the housing; and
the RFID tag being electronically connected to the mother board.

19. The internet video chat capable television with integrated personal computer hardware as claimed in claim 16, wherein the remote comprises a QWERTY keyboard.

20. The internet video chat capable television with integrated personal computer hardware as claimed in claim 16, wherein the digital screen is a liquid crystal display, a light emitting diode display, or a plasma screen.
